(19) United States
(12) Patent Application Publication
(10) Pub. No.: US 2017/0200185 A1
(43) Pub. Date: Jul. 13, 2017

(54) METHOD AND SYSTEM FOR PROVIDING A LOYALTY PROGRAM TO A USER OF A MULTI-USER TRANSPORTATION SYSTEM AND USE THEREOF

(71) Applicant: Ari Kugler, Westmount (CA)

(72) Inventor: Ari Kugler, Westmount (CA)

(21) Appl. No.: 15/403,632

(22) Filed: Jan. 11, 2017

Related U.S. Application Data
(60) Provisional application No. 62/277,699, filed on Jan. 12, 2016.
(60) Provisional application No. 62/298,500, filed on Feb. 23, 2016.

(51) Int. Cl. G06Q 30/02; H04W 4/02

(52) U.S. Cl. CPC G06Q 30/0233; H04W 4/02

(57) ABSTRACT

A method for providing a loyalty program to a user of a multi-user transportation system, the user carrying a processing device, the method comprising detecting a position of a start of a trip using the processing device, wherein the trip involves use of a multi-user transportation system on at least one portion of it; detecting a position of an end of the trip using the processing device; identifying a trip itinerary made by the user in the multi-user transportation system using at least the position of the start of the trip and the position of the end of the trip; determining a corresponding credit to be allocated to the user based on at least the identified trip itinerary made; allocating the corresponding credit to the user and providing the user with a user interface for enabling the user to exchange at least one portion of the allocated credit for at least one of a good and a service.

### CROSS-REFERENCE TO RELATED APPLICATIONS

The present patent application claims priority on U.S. Provisional Patent Applications No. 62/277,699, filed on Jan. 12, 2016, and No. 62/298,500, filed on Feb. 23, 2016, the subject matter of which is incorporated herein by reference.

### FIELD

The invention relates to computers. More precisely, this invention relates to a method and system for providing a loyalty program to a user of a multi-user transportation system and use thereof.

### BACKGROUND

Various loyalty programs have been developed.

Usually a loyalty program member is provided with a card and a corresponding account is credited following a given action.

For instance, when doing groceries, a user may be credited with a given amount of points depending on an amount of money spent at the grocery store. To do so, the user will present a corresponding loyalty card to the cashier and the account of the user will be credited accordingly.

In the transportation industry, most airline companies have loyalty programs.

The user is again provided with a card and a corresponding account number and usually earns points based on a distance traveled. To do so, the user will, for instance, provide a corresponding account number during the booking or at checking in, in order to obtain such credit.

While many variants exist for the implementation of the program, the prior art suffers from many disadvantages.

A first disadvantage is that the user may have to proactively interact with someone to register a transaction in the loyalty program, which can be cumbersome. This is the case at the grocery store, where the user will have to present the card to the cashier.

Another disadvantage is that the user may have to wait in order to obtain corresponding credit in its account. It may take a couple of days or weeks before a transaction is registered in the system.

Another disadvantage of some prior-art loyalty programs is that they may be limited to an amount of money spent.

Another disadvantage of some prior-art loyalty programs is that they may be vendor-specific.

Another disadvantage of some prior-art loyalty programs is that a transaction may have to be actively performed by a user.

There is therefore a need for a method and system that will overcome at least one of the above-identified drawbacks.

Features of the invention will be apparent from review of the disclosure, drawings and description of the invention below.

### BRIEF SUMMARY

According to a broad aspect, there is disclosed a method for providing a loyalty program to a user of a multi-user transportation system, the user carrying a processing device, the method comprising detecting a position of a start of a trip using the processing device, wherein the trip involves use of a multi-user transportation system on at least one portion of it; detecting a position of an end of the trip using the processing device; identifying a trip itinerary made by the user in the multi-user transportation system using at least the position of the start of the trip and the position of the end of the trip; determining a corresponding credit to be allocated to the user based on at least the identified trip itinerary made; allocating the corresponding credit to the user; providing the user with a user interface for enabling the user to exchange at least one portion of the allocated credit for at least one of a good and a service.

According to an embodiment, the multi-user transportation system is selected from a group consisting of at least one of a subway system, a railroad system, a bus system, a public bike-sharing system and a system comprising a network of taxis.

According to an embodiment, the detecting of the position of a start of a trip and the detecting of the position of an end of the trip is performed using a positioning system integrated in the mobile processing device.

According to an embodiment, the detection of the position of a start of a trip comprises detecting an interaction with the mobile processing device.

According to an embodiment, the interaction is selected from a group consisting of an interaction of the user with an application running on the mobile processing device and an interaction between the mobile processing device and a mobile detection unit located in the surrounding of the mobile processing device.

According to an embodiment, the interaction between the mobile processing device and the mobile detection unit located in the surrounding of the mobile processing device is performed using a short-range wireless data network.

According to an embodiment, the short-range wireless data network operates using one of a WIFI and Bluetooth connection.

According to an embodiment, the detecting of a position of a start of a trip comprises detecting when a set of conditions is met.

According to an embodiment, the set of conditions comprises one of reaching a location and a given time.

According to an embodiment, the detecting of the position of the end of the trip is performed using a mobile detection unit.

According to an embodiment, the multi-user transportation system is comprised of a plurality of vehicles; further wherein the identifying of the trip itinerary made by the user is performed using a plurality of schedules associated with the vehicles of the multi-user transportation system.

According to an embodiment, the plurality of schedules is obtained from a website of the multi-user transportation system.

According to an embodiment, the determining of a corresponding credit to be allocated to the user based on at least the identified trip itinerary is made using additional parameters.

According to an embodiment, the additional parameters are selected from a group consisting of a time of day, a user profile and presence or absence of at least one other user.

According to an embodiment, the providing of the user with a user interface for enabling the user to exchange at least one portion of the allocated credit for at least one of a good and a service comprises the user accessing a server.

According to a broad aspect, there is disclosed a loyalty program processing device comprising a central processing unit; a display device; a communication port for operatively connecting the processing device to a plurality of processing devices, each carried by a user; a memory unit comprising an application for providing a loyalty program, the application comprising instructions for detecting a position of a start of a trip of a user using a processing device carried by the user, wherein the trip involves use of a multi-user transportation system on at least one portion of it; instructions for detecting a position of an end of the trip using the processing device carried by the user; instructions for identifying a trip itinerary made by the user in the multi-user transportation system using at least the position of the start of the trip and the position of the end of the trip; instructions for determining a corresponding credit to be allocated to the user based on at least the identified trip itinerary made; instructions for allocating the corresponding credit to the user; instructions for providing the user with a user interface for enabling the user to exchange at least one portion of the allocated credit for at least one of a good and a service.

According to a broad aspect, there is disclosed a non-transitory computer-readable storage medium for storing computer-executable instructions which, when executed, cause a processing device to perform a method for providing a loyalty program to a user of a multi-user transportation system, the user carrying a processing device; the method comprising detecting a position of a start of a trip using the processing device, wherein the trip involves use of a multi-user transportation system on at least one portion of it; detecting a position of an end of the trip using the processing device; identifying a trip itinerary made by the user in the multi-user transportation system using at least the position of the start of the trip and the position of the end of the trip; determining a corresponding credit to be allocated to the user based on at least the identified trip itinerary made; allocating the corresponding credit to the user and providing the user with a user interface for enabling the user to exchange at least one portion of the allocated credit for at least one of a good and a service.

An advantage of the method disclosed is that it enables users to be rewarded based on trips made in a multi-user transportation system.

Another advantage of the method disclosed herein is that a user may be quickly credited depending on a trip itinerary made.

Another advantage of the method disclosed is that the user does not have to interact with someone to credit a trip.

Another advantage of the method disclosed herein is that data collected from the user of the multi-user transportation system may be used to derive information about the operations of the multi-user transportation system. For instance, information such as waiting time information, traffic information, etc., may be derived from the data collected. Such information may be used to optimize the operations of the multi-user transportation system.

### BRIEF DESCRIPTION OF THE DRAWINGS

In order that the invention may be readily understood, embodiments of the invention are illustrated by way of example in the accompanying drawings.

FIG. 1 is a flowchart which shows an embodiment of a method for providing a loyalty program to a user of a multi-user transportation system;

FIG. 2 is a block diagram which shows a first embodiment of a system for providing a loyalty program to a user of a multi-user transportation system;

FIG. 3 is a block diagram which shows a second embodiment of a system for providing a loyalty program to a user of a multi-user transportation system;

FIG. 4 is a diagram which shows an embodiment of a loyalty program processing device;

FIG. 5 is a flowchart that shows a first embodiment for detecting a position of a start of a trip;

FIG. 6 is a flowchart that shows a second embodiment for detecting a position of a start of a trip;

FIG. 7 is a flowchart that shows a third embodiment for detecting a position of a start of a trip;

FIG. 8 is a flowchart that shows a first embodiment for detecting a position of an end of a trip;

FIG. 9 is a flowchart that shows an embodiment for identifying a trip itinerary; and

FIG. 10 is a flowchart that shows an embodiment for providing the user with a user interface.

Further details of the invention and its advantages will be apparent from the detailed description included below.

### DETAILED DESCRIPTION

In the following description of the embodiments, references to the accompanying drawings are by way of illustration of an example by which the invention may be practiced.

### Terms

The term “invention” and the like mean “the one or more inventions disclosed in this application,” unless expressly specified otherwise.

The terms “an aspect,” “an embodiment,” “embodiment,” “embodiments,” “the embodiment,” “the embodiments,” “one or more embodiments,” “some embodiments,” “certain embodiments,” “one embodiment,” “another embodiment” and the like mean “one or more (but not all) embodiments of the disclosed invention(s),” unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including,” “comprising” and variations thereof mean “including but not limited to,” unless expressly specified otherwise.

The terms “a,” “an” and “the” mean “one or more,” unless expressly specified otherwise.

The term “plurality” means “two or more,” unless expressly specified otherwise.

The term “herein” means “in the present application, including anything which may be incorporated by reference,” unless expressly specified otherwise.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example,” and thus do not limit the terms or phrases they explain. For example, in a sentence “the computer sends data (e.g., instructions, a data structure) over the Internet,” the term “e.g.” explains that “instructions” are an example of “data” that the computer may send over the Internet, and also explains that “a data structure” is an example of “data” that the computer may send over the Internet. However, both “instructions” and “a data structure” are merely examples of “data,” and other things besides “instructions” and “a data structure” can be “data.”

The term “i.e.” and like terms mean “that is,” and thus limit the terms or phrases they explain.

The term “multi-user transportation system” and like terms mean a system providing or facilitating the providing of transportation to a plurality of users. The system may be privately operated or publicly operated. In one embodiment, the multi-user transportation system is selected from a group consisting of at least one of a subway system, a railroad system, a bus system, public bike-sharing system, a system comprising a network of taxis, and the like. Alternatively, the system may be an application for facilitating the providing of transportation to a plurality of users such as, for instance, Uber™.

Neither the Title nor the Abstract is to be taken as limiting in any way as the scope of the disclosed invention(s). The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

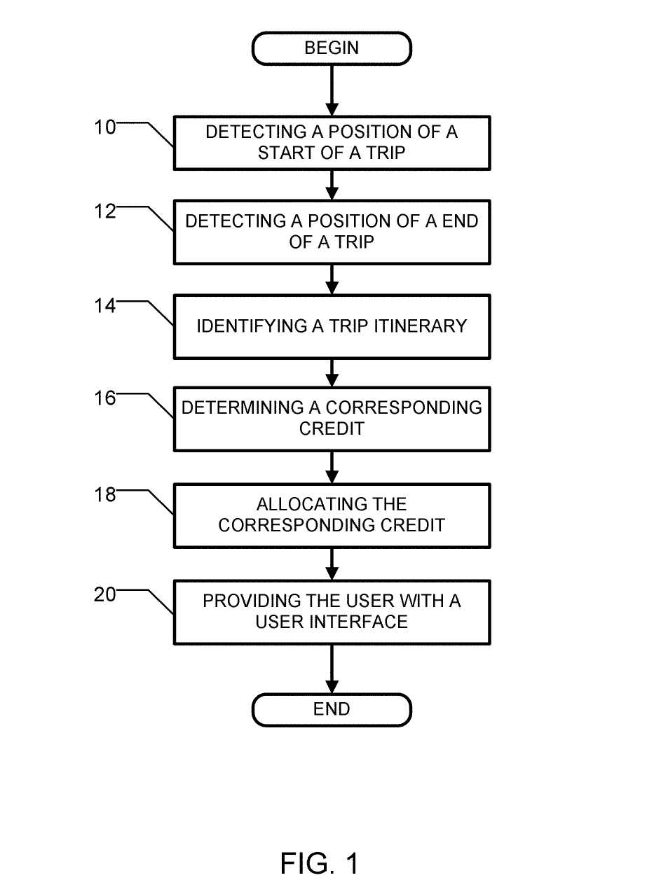

Now referring to FIG. 1, there is shown an embodiment of a method for providing a loyalty program to a user of a multi-user transportation system.

In this embodiment, the user carries a mobile processing device.

It will be appreciated that the mobile processing device may be of various types, as further explained below.

As mentioned above, it will be appreciated that the multi-user transportation system may be of various types. In one embodiment, the multi-user transportation system is selected from a group consisting of at least one of a subway system, a railroad system, a bus system, public bike-sharing system, a system comprising a network of taxis, and the like.

In one embodiment, the multi-user transportation system comprises a network composed of a subway system and a bus system of a given city.

As known to the skilled addressee, it will be appreciated that the size of a multi-user transportation system may greatly vary depending on a geographic location. Moreover, it will be appreciated that the coverage of a multi-user transportation system may not be limited to a given specific area. In fact, the multi-user transportation system may be deployed in at least one of a city, a city and a suburb, a department, a region, a country, and a continent.

It will be appreciated that the mobile processing device may be carried by the user according to various embodiments.

In one embodiment, the mobile processing device is carried by the user in a way that is visible to him/her. In an alternative embodiment, the mobile processing device is concealed from the view of the user and may be, for instance, located in a pocket of a garment worn by the user.

Still referring to FIG. 1 and according to processing device 10, a position of a start of a trip is detected.

It will be appreciated that the position of a start of a trip may be detected according to various embodiments.

In on embodiment, the position is detected by the mobile processing device itself.

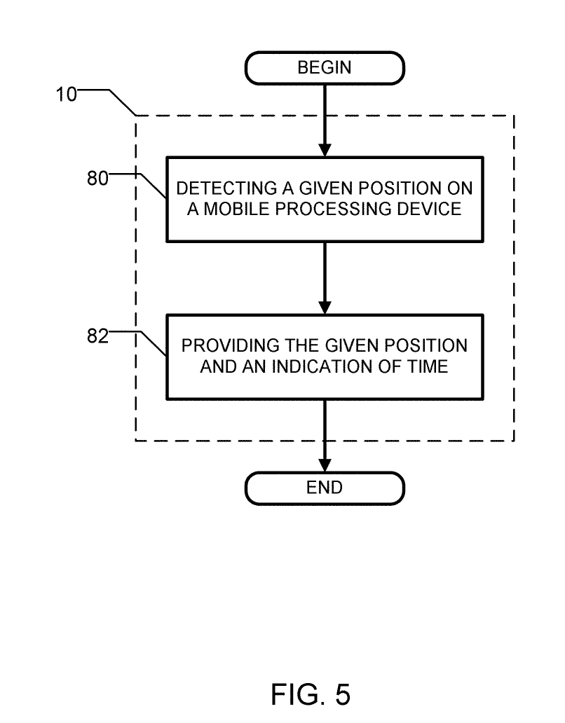

Now referring to FIG. 5, there is shown a first embodiment for detecting a position of a start of a trip.

According to processing step 80, a given position is detected using a mobile processing device.

It will be appreciated that the given position may be detected using the mobile processing device of the user according various embodiments.

This may be performed, for instance, using a positioning system integrated in the mobile processing device.

The positioning system may be one of a Global Positioning System (GPS) receiver and a GlObal Navigation SyStem receiver (GLONASS).

The skilled addressee will appreciate that various alternative embodiments may be provided.

According to processing step 82, the given position and indication of time are provided.

The given position and the indication of time may be provided according to various embodiments.

In one embodiment, the given position and the indication of time are provided to the loyalty program processing device.

In another alternative embodiment, the given position and the indication of time are stored in the mobile processing device temporarily.

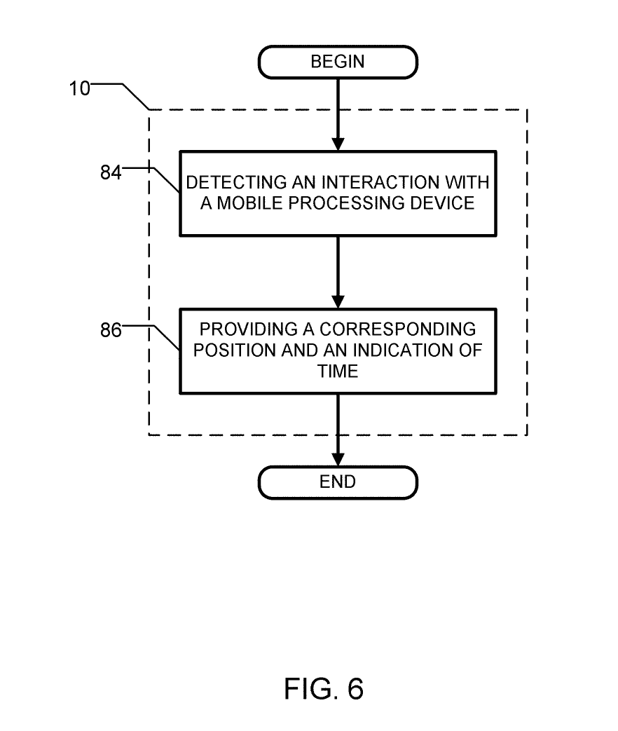

Now referring to FIG. 6, there is shown a second embodiment for detecting a position of a start of a trip.

According to processing step 84, an interaction with a mobile processing device is detected. It will be appreciated that the interaction with the mobile processing device may be detected according to various embodiments.

In one embodiment, the user will interact with an application executed on the mobile processing device.

In another embodiment, an interaction with the mobile processing device will be detected with a mobile detection unit located in the surrounding of the mobile processing device. The interaction with a mobile detection unit may be performed in a short-range wireless data network such as Bluetooth or Wifi.

According to processing step 86, a corresponding position and an indication of time are provided.

It will be appreciated that the corresponding position and the indication of time may be provided according to various embodiments.

In one embodiment, the corresponding position and the indication of time may be provided by the mobile processing unit to the loyalty program processing device 22 via the data network 26.

In an alternative embodiment, the corresponding position and the indication of time are temporarily stored in the mobile processing device.

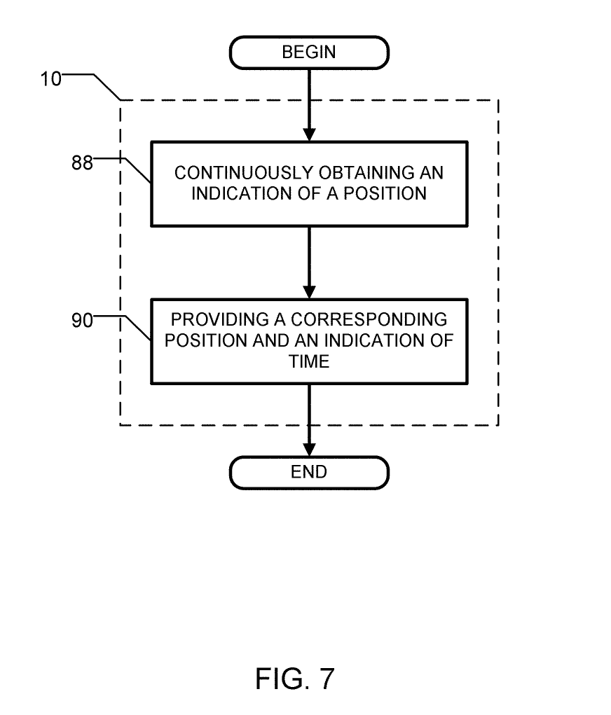

Now referring to FIG. 7, there is shown a third embodiment for detecting a position of a start of a trip.

According to processing step 88, an indication of position is continuously obtained on the mobile processing device.

It will be appreciated that the indication of a position is continuously obtained following an interaction with the mobile device.

Such interaction may be performed by the user. In an alternative embodiment, the interaction with the mobile processing device may be performed automatically, such as, for instance, when a set of conditions is met.

For instance, such set of conditions may comprise reaching a given location or a given time.

According to processing step 90, a corresponding position and an indication of time are provided.

It will be appreciated that the corresponding position and the corresponding indication of time may be provided to the loyalty program processing device 22 according to various embodiments.

In one embodiment, the corresponding position and the corresponding indication of time are provided via the data network 26.

In an alternative embodiment, the corresponding position and the corresponding indication of time are stored temporarily in the mobile processing device.

Now referring back to FIG. 1 and according to processing step 12, a position of an end of a trip is detected.

It will be appreciated that the detection of the position of an end of a trip may be performed according to various embodiments.

In one embodiment, the position of an end of a trip is detected using the mobile processing device itself.

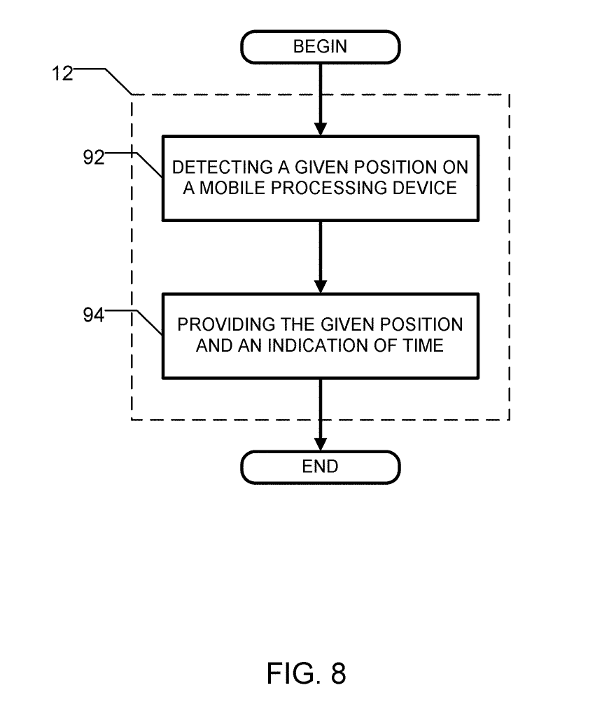

Now referring to FIG. 8, there is shown such embodiment where the given position is detected using the mobile processing device itself.

This may be performed, for instance, using a positioning system integrated in the mobile processing device.

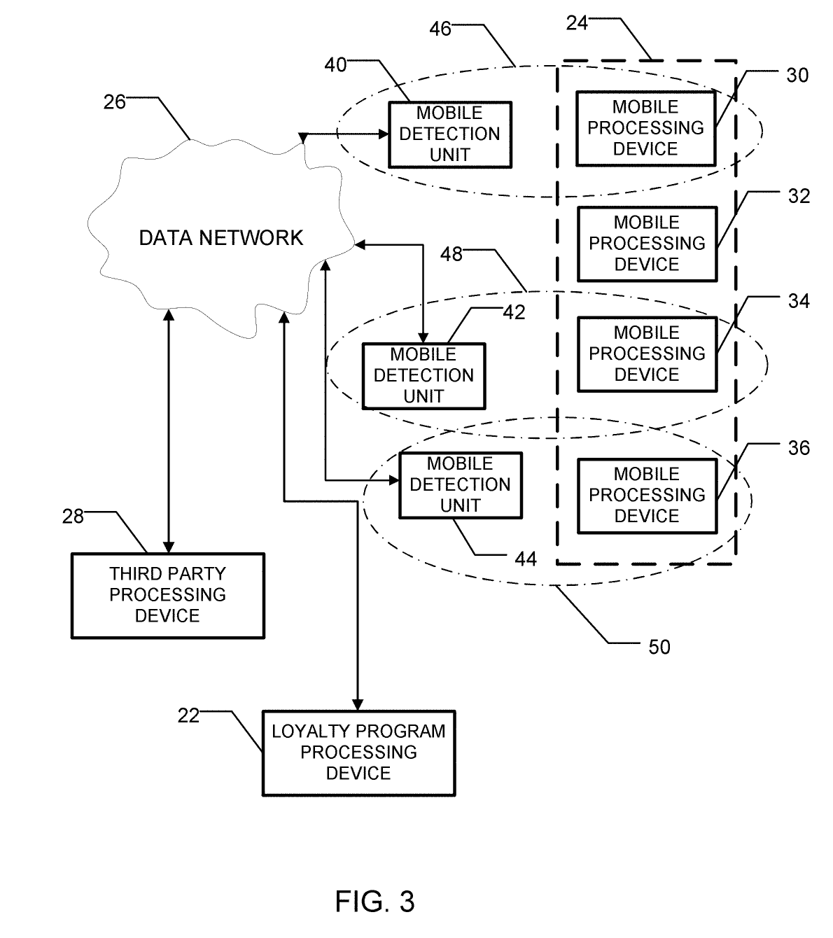

In an alternative embodiment, the given position is detected using a mobile detection unit such as the ones shown in FIG. 3.

According to processing step 94, a given position and an indication of time are provided. It will be appreciated that the given position and the indication of time may be provided according to various embodiments.

In one embodiment, the corresponding given position and the indication of time are provided to the loyalty program processing device 22 via the data network 26.

In an alternative embodiment, the corresponding given position and the indication of time are stored temporarily in the mobile processing device itself.

According to processing step 14, a trip itinerary is identified. It will be appreciated that the trip may be identified according to various embodiments.

In one embodiment, the trip itinerary is identified using the position of a start of a trip and the position of an end of the trip.

In fact, it will be appreciated that in one embodiment, a correlation may be performed using data collected using the mobile processing device and data stored in the loyalty program processing device.

The data that are stored in the loyalty program processing device and that are used for determining a trip itinerary may be of various types.

For instance, and in accordance with a first embodiment, the data that are stored in the loyalty program processing device and that are used for determining a trip itinerary may comprise a plurality of schedules associated with the vehicles of the multi-user transportation system. The plurality of schedules may be obtained according to various embodiments. For instance, the plurality of schedules may be obtained from a website of the multi-user transportation system.

In accordance with a second embodiment, the data that are stored in the loyalty program processing device and that are used for determining a trip itinerary may be generated in real-time. Those data may be generated using a device generating and reporting a current position of a vehicle in real-time. The device may be located onboard a vehicle of the multi-user transportation system.

It will be appreciated that the purpose of the correlation is to associate a user with an itinerary. It will be appreciated that in one embodiment the correlation may require a plurality of matching points in order to validate that a given user has been on a given itinerary.

Following the correlation a trip itinerary will be identified for the user carrying the mobile processing device.

It will be appreciated that the trip itinerary may comprise various information of interest which may be further obtained from other data sources.

According to processing step 16, a corresponding credit is determined.

It will be appreciated by the skilled addressee that the corresponding credit may be determined according to various embodiments.

In one embodiment, the corresponding credit is determined using the trip itinerary identified following the correlation.

It will be further appreciated that the corresponding credit may be determined using additional parameters such as, for instance, a time of day, a user profile, a segment, the presence or absence of other users, etc.

Still referring to FIG. 1 and according to processing step 18, the corresponding credit is allocated to the user.

Again, it will be appreciated by the skilled addressee that the corresponding credit for the determined trip may be allocated to the user according to various embodiments.

In one embodiment, the user is registered in the loyalty program processing device 22 and the corresponding credit is allocated to the user's' account.

It will be appreciated that the corresponding credit may be indicated to the user using various metrics such as points, miles, etc.

According to processing step 20, the user is provided with a user interface.

It will be appreciated that the user interface may be provided to the user according to various embodiments.

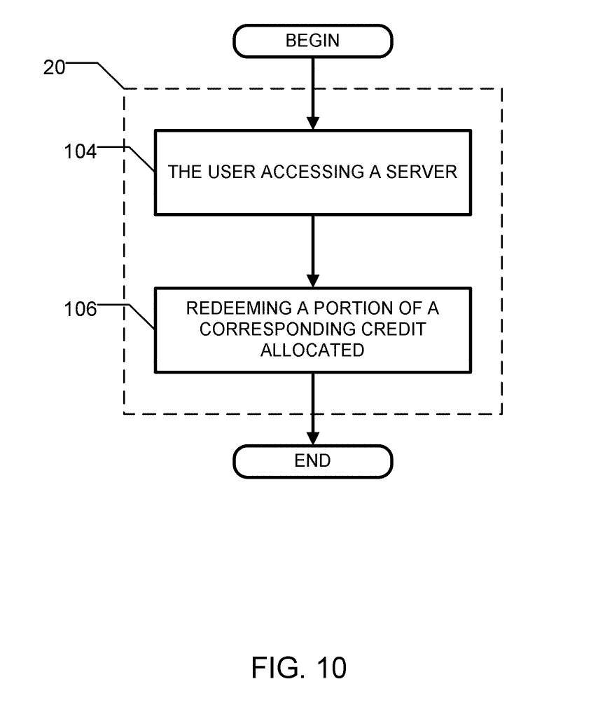

Now referring to FIG. 10, there is shown an embodiment for providing the user with a user interface.

According to processing step 104, a server is accessed by the user.

It will be appreciated that the server is accessed by the user according to various embodiments.

In fact, while there is shown an embodiment wherein the server is integrated in the loyalty program processing device, it will be appreciated by the skilled addressee that in an alternative embodiment, the server may be located at another location.

In one embodiment, the server is accessed by the user via the mobile processing device via the data network. It will be appreciated that the server may be accessed via a dedicated application executed on the mobile processing device. In an alternative embodiment, the server is accessed using a browser application executed on the mobile processing device.

In an alternative embodiment, the server is accessed by the user using another processing device such as a desktop computer or the like.

It will be appreciated that the other processing device is operatively connected to the server via a data network.

In such embodiment, the user may execute a browser application on the other processing device to access the server.

According to processing step 106, a portion of a corresponding credit allocated is redeemed.

It will be appreciated that the portion of a corresponding credit allocated may be redeemed according to various embodiments.

In one embodiment, the portion of the corresponding credit allocated is redeemed by selecting at least one of a good and service displayed on the user interface provided by the server.

It will be appreciated that the at least one good and service may be offered by a third party.

In such embodiment, a third-party processing device may be used to populate a list of good and services available.

The third party processing device may access the loyalty program processing device via the data network.

The skilled addressee will appreciate that various alternative embodiments may be provided.

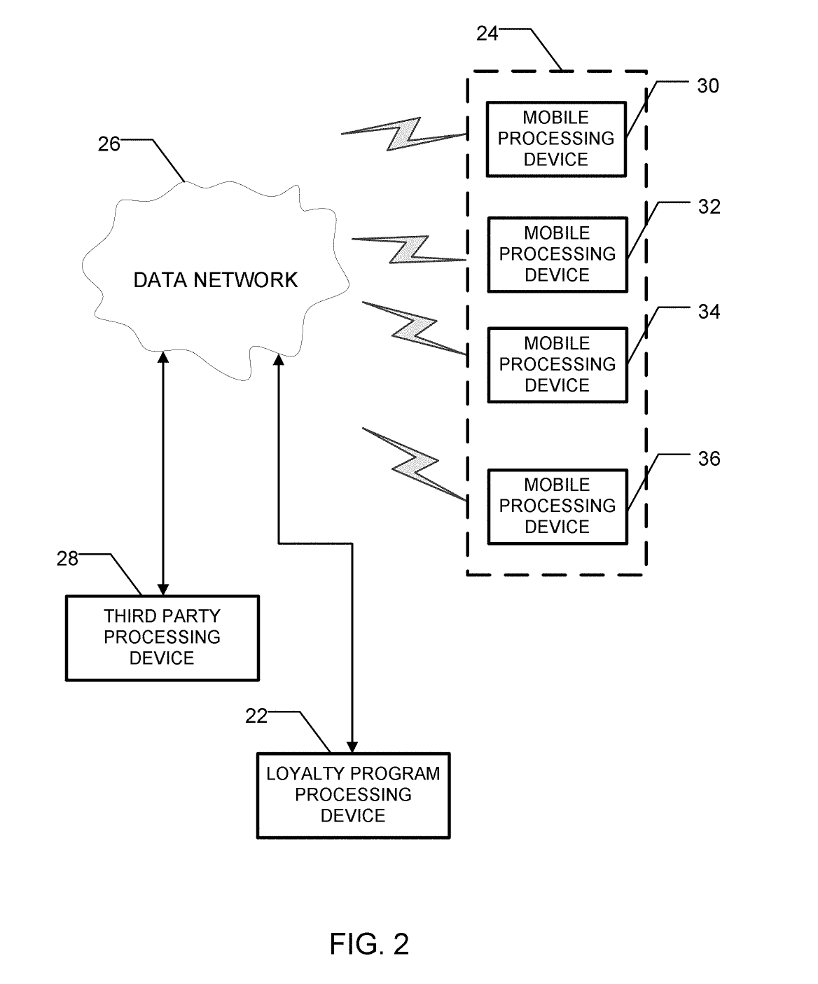

Now referring to FIG. 2, there is shown a first embodiment of a system for providing a loyalty program to a user of a multi-user transportation system with the user carrying a processing device.

The system comprises a loyalty program processing device 22, a plurality of mobile processing devices 24, a data network 26 and a third party processing device 28.

The loyalty program processing device 22 is used for providing the loyalty program to a plurality of users of a given multi-user transportation system.

It will be appreciated that the loyalty program processing device 22 may be of various types.

In one embodiment, the loyalty processing device 22 is selected from a group consisting of laptop computer, desktop computer, servers, etc.

In a preferred embodiment, the loyalty program processing device 22 comprises a server.

The plurality of mobile processing devices 24 comprises a first mobile processing device 30, a second mobile processing device 32, a third mobile processing device 34, and a N^{th} mobile processing device 36. Each of the first mobile processing device 30, the second mobile processing device 32, the third mobile processing device 34, and the N^{th} mobile processing device 36 is operatively connected with a data network 26.

It will be further appreciated that each of the plurality of mobile processing devices 24 may be selected from a group consisting of smartphones, PDAs, tablet PCs and electronic watches.

In a one embodiment, the plurality of mobile processing devices 24 is wirelessly connected to the data network 26.

It will be further appreciated that each of the plurality of mobile processing devices 24 is carried by a corresponding user using the multi-user transportation system.

The third-party processing device 28 is used by a third party to provide data to the loyalty program processing device 22.

The third-party processing device 28 is used to provide the data to the loyalty program processing device 22 via the data network 26.

It will be appreciated that the third-party processing device 28 may be connected to the data network 26 according to various embodiments.

Similarly, it will be appreciated that the loyalty program processing device 22 is connected to the data network 26 according to various embodiments.

It will be appreciated that the data network 26 may be of various types.

In one embodiment, the data network 26 is selected from a group consisting of a local area network (LAN), a metropolitan area network (MAN) and a wide area network (WAN).

In one embodiment, the data network 26 comprises the Internet.

Now referring to FIG. 3, there is shown another embodiment of a system for providing a loyalty program to a user of a multi-user transportation system.

In this embodiment, the system comprises a first mobile detection unit 40, a second mobile detection unit 42 and a third mobile detection unit 44.

Each of the first mobile detection unit 40, the second mobile detection unit 42 and the third mobile detection unit 44 has a dedicated corresponding area labeled respectively 46, 48 and 50 for detecting at least one mobile processing device therein.

In case of a detection, the mobile detection unit will provide a signal indicative of detection to the loyalty program processing device 22.

The signal indicative of detection will be provided by the mobile detection unit to the loyalty program processing device 22 via the data network 26.

It will be appreciated that the mobile detection unit may be connected to the data network 26 according to various embodiments.

As shown in FIG. 3, the first mobile detection unit 40 is capable of detecting the first mobile processing device 30 of the plurality of mobile processing devices 24. The second mobile detection unit 42 is capable of detecting the third mobile processing device 343 of the plurality of mobile processing devices 24, while the third mobile detection unit 44 is capable of detecting the N^{th} mobile processing device 36 of the plurality of mobile processing devices 24.

It will be appreciated that each of the first mobile detection unit 40, the second mobile detection unit 42 and the third mobile detection unit 44 may be located at a strategic location within the multi-user transportation system. A strategic location is defined as a location which can be used in the process for determining a trip made by the user.

In the case where the multi-user transportation system is a bus network, the mobile detection units may be located in at least one of a bus stop and a bus.

The skilled addressee will appreciate that various alternative embodiments may be possible.

For instance, the mobile detection units may be located at fixed locations. Alternatively, the mobile detection units may be other mobile processing devices having position providing capabilities.

As such, the mobile detection unit will be capable of detecting a presence of a corresponding mobile processing device within its range. The skilled addressee will appreciate that the providing of a mobile detection unit will remove the need for the mobile processing device to have a device for providing an indication of the location of the mobile processing device. As further explained below, it will be appreciated that the mobile detection unit may be of various types.

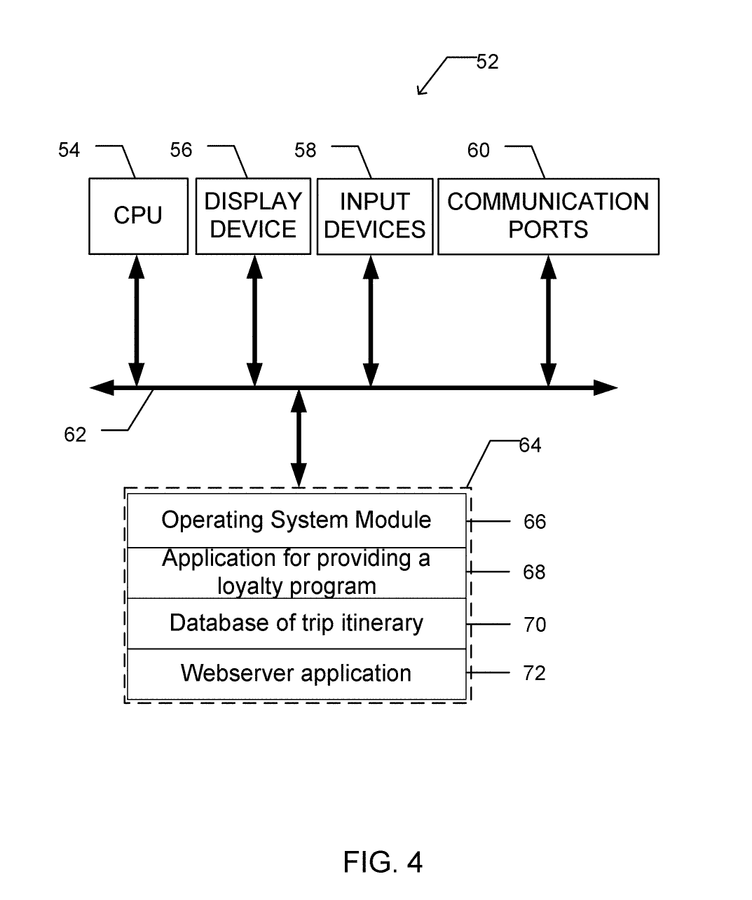

Now referring to FIG. 4, there is shown an embodiment of a loyalty program processing device 22.

The loyalty program processing device 22 comprises a central processing unit 54, a display device 56, input devices 58, communication ports 60, a data bus 62 and a memory unit 64.

The central processing unit 54, the display device 56, the input devices 58, the communication ports 60 and the memory unit 64 are interconnected using the data bus 62.

The central processing unit 54 is used for processing computer instructions. The skilled addressee will appreciate that various embodiments of the central processing unit 54 may be provided.

In one embodiment, the central processing unit 54 is a CPU Core i7 3820 running at 3.6 GHz and manufactured by Intel™.

The display device 56 is used for displaying data to a user. The skilled addressee will appreciate that various types of display device 56 may be used.

In one embodiment, the display device 56 is a standard liquid-crystal display (LCD) monitor.

The communication ports 60 are used for sharing data with the loyalty program processing device 22.

The communication ports 60 may comprise, for instance, a universal serial bus (USB) port for connecting a keyboard and a mouse to the loyalty program processing device 22.

The communication ports 60 may further comprise a data network communication port such as an IEEE 802.3 port for enabling a connection of the loyalty program processing device 22 with another processing device via a data network.

The skilled addressee will appreciate that various alternative embodiments of the communication ports 60 may be provided.

In one embodiment, the communication ports 60 comprise an Ethernet port and a mouse port (e.g., Logitech™).

The memory unit 64 is used for storing computer-executable instructions.

It will be appreciated that the memory unit 64 comprises, in one embodiment, an operating system module 66.

It will be appreciated by the skilled addressee that the operating system module 66 may be of various types.

In an embodiment, the operating system module 66 is Windows™ 8 manufactured by Microsoft™.

The memory unit 64 further comprises an application for providing a loyalty program 68.

The memory unit 64 further comprises a database of trip itinerary 70.

The data comprised in the database of trip itinerary 70 may be generated according to various embodiments.

In fact, it will be appreciated that the database of trip itinerary 70 may further comprise any type of data necessary for correlating a user to a given itinerary.

The memory unit 64 further comprises a webserver application 72.

It will be appreciated that the webserver application 72 may be of various types.

The application for providing a loyalty program 68 comprises instructions for detecting a position of a start of a trip using the processing device, wherein the trip involves use of a multi-user transportation system on at least one portion of it.

The application for providing a loyalty program 68 further comprises instructions for detecting a position of an end of the trip using the processing device.

The application for providing a loyalty program 68 comprises instructions for identifying a trip itinerary made by the user in the multi-user transportation system using at least the position of the start of the trip and the position of the end of the trip.

The application for providing a loyalty program 68 comprises instructions for determining a corresponding credit to be allocated to the user based on at least the identified trip itinerary made.

The application for providing a loyalty program 68 comprises instructions for allocating the corresponding credit to the user.

The application for providing a loyalty program 68 comprises instructions for providing the user with a user interface for enabling the user to exchange at least one portion of the allocated credit for at least one of a good and a service.

It will be appreciated that a non-transitory computer-readable storage medium is also disclosed for storing computer-executable instructions which, when executed, cause a processing device to perform a method for providing a loyalty program to a user of a multi-user transportation system, the user carrying a processing device. The method comprises detecting a position of a start of a trip using the processing device, wherein the trip involves use of a multi-user transportation system on at least one portion of it; detecting a position of an end of the trip using the processing device; identifying a trip itinerary made by the user in the multi-user transportation system using at least the position of the start of the trip and the position of the end of the trip; determining a corresponding credit to be allocated to the user based on at least the identified trip itinerary made; allocating the corresponding credit to the user and providing the user with a user interface for enabling the user to exchange at least one portion of the allocated credit for at least one of a good and a service.

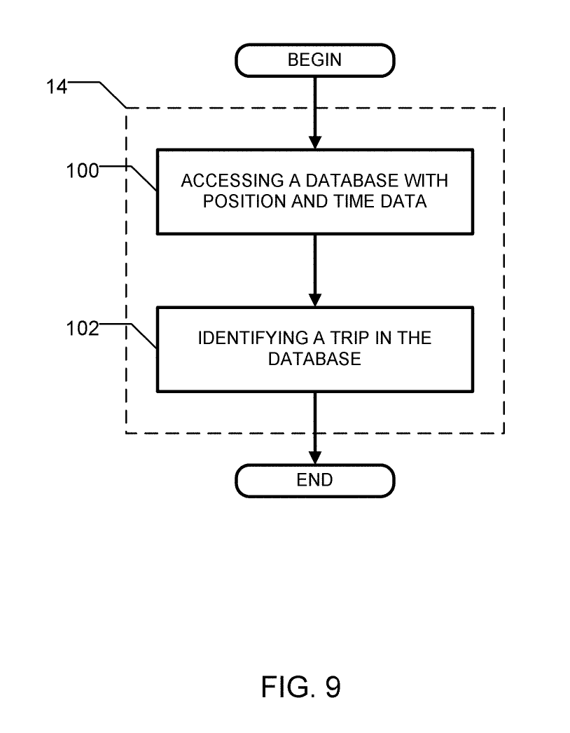

Now referring to FIG. 9, there is shown an embodiment for identifying a trip itinerary.

According to processing step 100, a database of trip itineraries is accessed. In one embodiment, the database of trip itineraries is accessed with provided position and time data.

According to processing step 102, a trip is identified in the database.

It will be appreciated that the trip may be identified according to various embodiments.

Although the above description relates to a specific preferred embodiment as presently contemplated by the inventor, it will be understood that the invention in its broad aspect includes functional equivalents of the elements described herein.

1. A method for providing a loyalty program to a user of a multi-user transportation system, the user carrying a processing device, the method comprising:
detecting a position of a start of a trip using the processing device, wherein the trip involves use of a multi-user transportation system on at least one portion of it;
detecting a position of an end of the trip using the processing device;
identifying a trip itinerary made by the user in the multi-user transportation system using at least the position of the start of the trip and the position of the end of the trip;
determining a corresponding credit to be allocated to the user based on at least the identified trip itinerary made;
allocating the corresponding credit to the user;
providing the user with a user interface for enabling the user to exchange at least one portion of the allocated credit for at least one of a good and a service.

2. The method as claimed in claim 1, wherein the multi-user transportation system is selected from a group consisting of at least one of a subway system, a railroad system, a bus system, a public bike-sharing system and a system comprising a network of taxis.

3. The method as claimed in claim 1, wherein the detecting of the position of a start of a trip and the detecting of the position of an end of the trip is performed using a positioning system integrated in the mobile processing device.

4. The method as claimed in claim 1, wherein the detection of the position of a start of a trip comprises detecting an interaction with the mobile processing device.

5. The method as claimed in claimed in 4, wherein the interaction is selected from a group consisting of an interaction of the user with an application running on the mobile processing device and an interaction between the mobile processing device and a mobile detection unit located in the surrounding of the mobile processing device.

6. The method as claimed in claim 5, wherein the interaction between the mobile processing device and the mobile detection unit located in the surrounding of the mobile processing device is performed using a short-range wireless data network.

7. The method as claimed in claim 6, wherein the short-range wireless data network operates using one of a WIFI and Bluetooth connection.

8. The method as claimed in claim 4, wherein the detecting of a position of a start of a trip comprises detecting when a set of conditions is met.

9. The method as claimed in claim 8, wherein the set of conditions comprises one of reaching a location and a given time.

10. The method as claimed in claim 1, wherein the detecting of the position of the end of the trip is performed using a mobile detection unit.

11. The method as claimed in claim 1, wherein the multi-user transportation system is comprised of a plurality of vehicles; further wherein the identifying of the trip itinerary made by the user is performed using a plurality of schedules associated with the vehicles of the multi-user transportation system.

12. The method as claimed in claim 11, wherein the plurality of schedules is obtained from a website of the multi-user transportation system.

13. The method as claimed in claim 1, wherein the determining of a corresponding credit to be allocated to the user based on at least the identified trip itinerary is made using additional parameters.

14. The method as claimed in claim 13, wherein the additional parameters are selected from a group consisting of a time of day, a user profile and presence or absence of at least one other user.

15. The method as claimed in claim 1, wherein the providing of the user with a user interface for enabling the user to exchange at least one portion of the allocated credit for at least one of a good and a service comprises the user accessing a server.

16. A loyalty program processing device comprising:
a central processing unit;
a display device;
a communication port for operatively connecting the processing device to a plurality of processing devices, each carried by a user;
a memory unit comprising an application for providing a loyalty program, the application comprising:
instructions for detecting a position of a start of a trip of a user using a processing device carried by the user, wherein the trip involves use of a multi-user transportation system on at least one portion of it;
instructions for detecting a position of an end of the trip using the processing device carried by the user;
instructions for identifying a trip itinerary made by the user in the multi-user transportation system using at least the position of the start of the trip and the position of the end of the trip;
instructions for determining a corresponding credit to be allocated to the user based on at least the identified trip itinerary made;
instructions for allocating the corresponding credit to the user;
instructions for providing the user with a user interface for enabling the user to exchange at least one portion of the allocated credit for at least one of a good and a service.

17. A non-transitory computer-readable storage medium for storing computer-executable instructions which, when executed, cause a processing device to perform a method for providing a loyalty program to a user of a multi-user transportation system, the user carrying a processing device; the method comprising detecting a position of a start of a trip using the processing device, wherein the trip involves use of a multi-user transportation system on at least one portion of it; detecting a position of an end of the trip using the processing device; identifying a trip itinerary made by the user in the multi-user transportation system using at least the position of the start of the trip and the position of the end of the trip; determining a corresponding credit to be allocated to the user based on at least the identified trip itinerary made; allocating the corresponding credit to the user and providing the user with a user interface for enabling the user to exchange at least one portion of the allocated credit for at least one of a good and a service.
